(19) United States
(12) Patent Application Publication
(10) Pub. No.: US 2006/0197319 A1
(43) Pub. Date: Sep. 7, 2006

(54) Airbag and airbag device

(75) Inventor: Atsushi Nakamura, Minato-ku (JP)

Correspondence Address: FITCH EVEN TABIN AND FLANNERY, 120 SOUTH LA SALLE STREET, SUITE 1600, CHICAGO, IL, 60603-3406, US

(73) Assignee: Takata Corporation, Minato-ku (JP)

(21) Appl. No.: 11/350,190

(22) Filed: Feb. 8, 2006

(30) Foreign Application Priority Data
Mar. 1, 2005 (JP) 2005-056077

(51) Int. Cl. B60R 21/233; B60K 28/10; B60R 21/34

(52) U.S. Cl. 280/729; 180/274

(57) ABSTRACT

An airbag that can inflate to ensure a sufficient thickness between a person and an object in an inflated state without using a high-output inflator, and an airbag device using the airbag are provided. In one form, an airbag includes one first bag disposed on an object side, and two second bags disposed on a person side. One end of a duct is sewn to the first bag. The other end of the duct surrounds an inflator. The first bag deploys toward an automobile, and the second bags deploy toward the person. The bags and communicate with each other through communicating openings.

### FIELD OF THE INVENTION

The present invention relates to an airbag that protects a person in a collision of the person with an object such as an automobile, and more particularly, to an airbag in which a plurality of bags are arranged in a colliding direction in order to ensure a sufficient thickness in an inflated state. The present invention also relates to an airbag device having the airbag.

### BACKGROUND OF THE INVENTION

Japanese Unexamined Patent Application Publication No. 2001-334895 discloses a pedestrian protection airbag as an airbag including a plurality of bags arranged in a colliding direction. FIG. 4 of the publication illustrates an airbag in which a small inner bag is disposed on a lower inner side of an outer bag that vertically and widely inflates along the front face of an automobile. Since the inner bag has a small capacity, it inflates earlier than the outer bag to receive the lower thigh of a pedestrian.

In the above airbag disclosed in Japanese Unexamined Patent Application Publication No. 2001-334895, the outer bag has a large capacity, and therefore, a high-output inflator is necessary to inflate the outer bag early.

### SUMMARY OF THE INVENTION

It is an object of the present invention to provide an airbag that can inflate to ensure a sufficient thickness between a person and an object in an inflated state without using a high-output inflator, and an airbag device using the airbag.

An airbag, in one form of the invention, protects a person by inflating between the person and an object in a collision therebetween, and includes a plurality of bags arranged in a colliding direction. The bags include a first bag disposed on an object side, and a second bag disposed on the outer side of the first bag and adjacently to a person side of the first bag.

In the above-described airbag, in another form, the second bag includes a plurality of second bags, the second bags are adjacently arranged in a direction orthogonal to the colliding direction, and the first bag is disposed between and on the object side of the second bags.

In the above-described airbag, in another form, a third bag is disposed between and on the person side of the second bags.

In any of the above-described airbags, in another form, the bag on the object side communicates with the adjacent bag on the person side through a communicating opening.

An airbag device includes the airbag according to any one of the above-described airbags, and an inflator for inflating the airbag.

In the airbag and the airbag device of the present invention, the second bag is disposed adjacently to the person side of the first bag disposed on the object side. The second bag is disposed on the outer side of the first bag, and has a capacity smaller than the outer bag that encloses the inner bag, as in Japanese Unexamined Patent Application Publication No. 2001-334895. Therefore, the entire airbag can be inflated early even by a low-output inflator.

In the airbag of one of the above-described forms, since a plurality of second bags are arranged in a direction orthogonal to the colliding direction, a large width of the airbag can be ensured in the direction orthogonal to the colliding direction. Moreover, since a plurality of second bags are arranged in the orthogonal direction, and a space is provided therebetween, the airbag has a capacity smaller than in a case in which an airbag made of one bag extends wide in the orthogonal direction.

Since the first bag is disposed between and on the object side of the second bags, a sufficient thickness of the airbag in the colliding direction can be also ensured between the second bags.

In the airbag in another one of the above-described forms, the third bag is disposed on the person side of the second bags, and this can further increase the thickness of the airbag in the colliding direction. In this case, a space is provided between the bags, the airbag has a capacity smaller than that of an airbag made of one bag.

According to the airbag in another one of the above-described forms, the inflator is disposed on the object side, and the bags can be inflated by gas from the inflator.

### BRIEF DESCRIPTION OF THE DRAWINGS

FIG. 1 is a perspective view of an airbag according to an embodiment.

FIG. 2 is a cross-sectional view, taken along line II-II in FIG. 1.

FIG. 3 is a schematic sectional view showing a non-inflation state of the same airbag section as that in FIG. 2 in order to explain sewing of the airbag.

FIG. 4 is an exploded perspective view of the airbag.

FIG. 5(a) is a perspective view of the front of an automobile having the airbag, and FIG. 5(b) is a cross-sectional view, taken along line B-B in FIG. 5(a).

FIG. 6 includes perspective views of airbags according to other embodiments.

FIG. 7 is a side view showing the interior of an automobile having a curtain airbag.

### DETAILED DESCRIPTION OF THE PREFERRED EMBODIMENTS

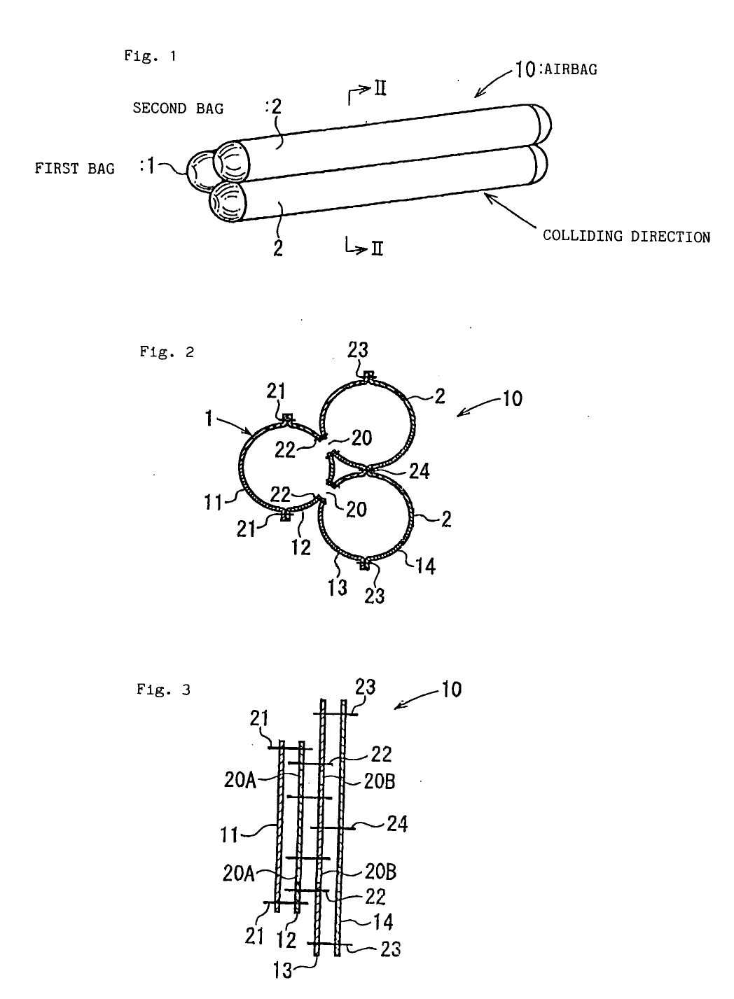

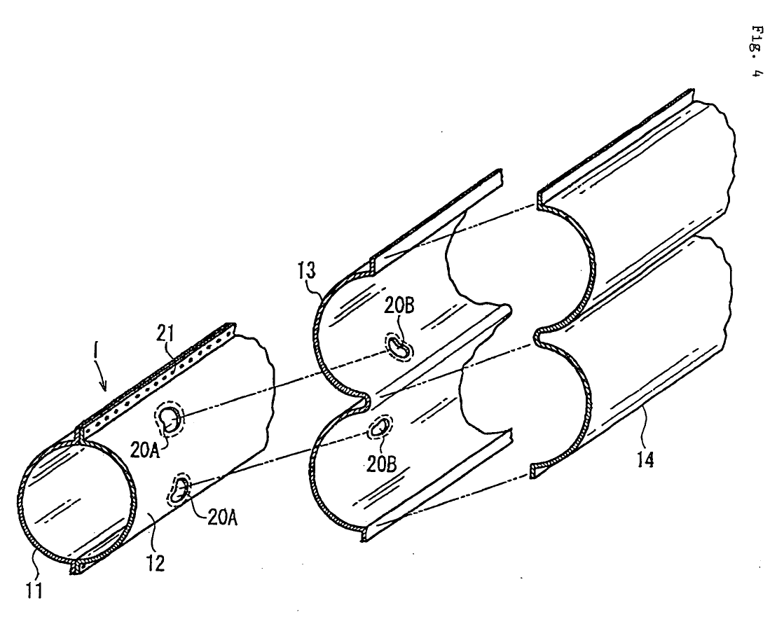

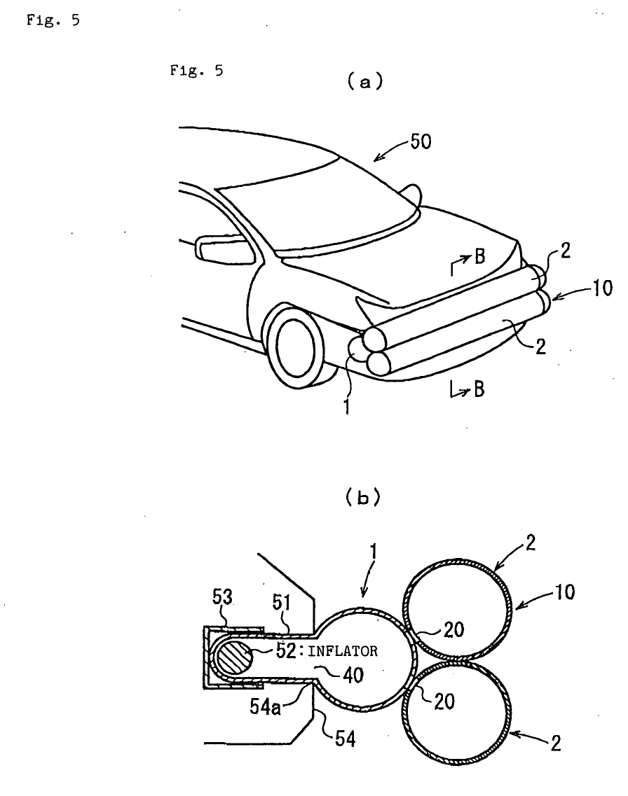

An embodiment will be described below with reference to the drawings. FIG. 1 is a perspective view of an airbag according to the embodiment, FIG. 2 is a cross-sectional view, taken along line II-II in FIG. 1, FIG. 3 is a schematic sectional view showing a non-inflation state of the same airbag section as that in FIG. 2 in order to explain sewing of the airbag, FIG. 4 is an exploded perspective view of the airbag, FIG. 5(a) is a perspective view of the front of an automobile having the airbag, and FIG. 5(b) is a cross-sectional view, taken along line B-B in FIG. 5(a).

An airbag 10 includes one first bag 1 on an object side, and two second bags 2 on a person side. The bags 1 and 2 are inflated into a cylindrical shape. The first bag 1 is disposed between and on the object side of the inflated bags 2 and 2.

The airbag 10 is formed by sewing first to fourth panels 11 and 14 made of, for example, cloth.

As clearly shown in FIGS. 3 and 4, the first panel 11 on the object side and the second panel 12 on the person side are substantially rectangular, have the same size, and are sewn by seams 21 along their entire lengths. The first bag 1 is formed by sewing the panels 11 and 12 at the seams 21 along their entire lengths.

The third panel 13 is disposed on the person side of the second panel 12, and the fourth panel 14 is disposed on the person side of the third panel 13. These panels 13 and 14 are substantially rectangular, have the same size, and are sewn by seams 23 along their entire lengths. The panels 13 and 14 are also sewn at the center by a seam 24 extending in the longitudinal direction, and the two second bags 2 are formed thereby.

Apertures 20A and 20B are provided in overlapping portions between the second and third panels 12 and 13, and portions around the rims of the apertures 20A and 20B are sewn by seams 22. The bags 1 and 2 are connected thereby. Communicating openings 20 (FIG. 2) that connect the interiors of the bags 1 and 2 are formed by aligning the apertures 20A and 20B.

As shown in FIG. 5(b), a gas inlet 40 is provided on the object side (the side of an automobile 50) of the first bag 1, and a cylindrical duct 51 extends from the gas inlet 40. The other end of the duct 51 surrounds an inflator 52. The duct 51 may be provided integrally with the first bag 1, or may be separately provided and be sewn to the first bag 1.

The airbag 10 is folded and stowed in a case 53, and the case 53 is disposed at the front of the automobile 50. A bumper 54 of the automobile has an opening 54a that permits the inflated and deployed airbag 10 to pass therethrough. The opening 54a is closed by a tearable lid (not shown).

When a collision between the automobile 50 and a person is predicted, the inflator 52 is activated, and the airbag 10 inflates along the forefront face of the automobile 50. As shown in FIG. 5, the first bag 1 deploys on the side of the automobile 50, and the second bags 2 deploy on the person side. The inflated bag 10 receives the person, thereby absorbing an impact made on the person by the collision.

Since the two second bags 2 and 2 are arranged in the vertical direction orthogonal to the direction in which the direction of collision with the person in the air bag 10, the vertical width of the airbag 10 in the vertical direction is sufficiently large. Moreover, since the first bag 1 is disposed between the second bags 2 and the automobile 50, a sufficient thickness is also ensured in the colliding direction. In addition, since the bags 1 and 2 are made of separate cylinders, and a space is provided therebetween, the capacity is smaller than that of a single airbag having a size such as to enclose the bags 1 and 2. Therefore, the airbag 10 inflates sufficiently early even when the inflator 52 has a small volume.

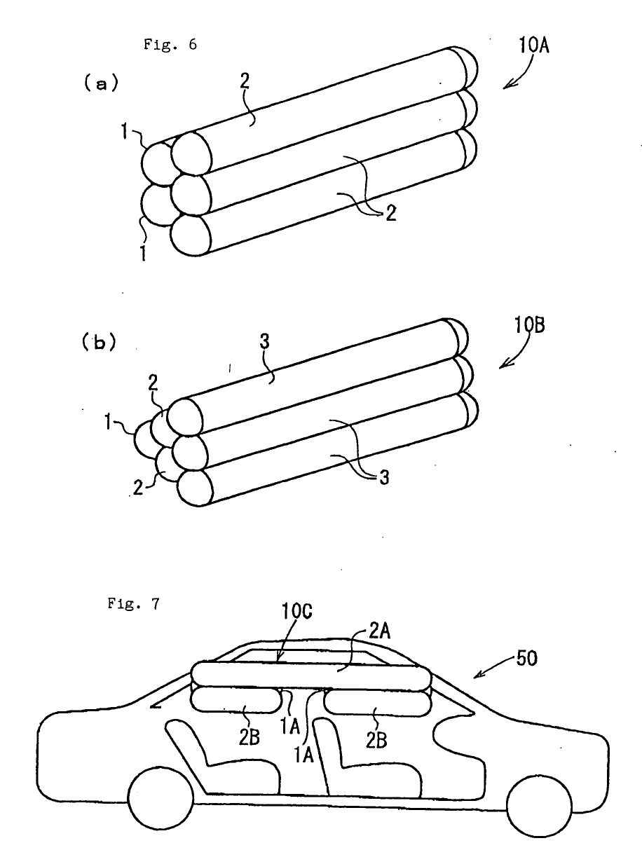

While the above airbag 10 includes one bag 1 and two bags 2 and 2, it may include two bags 1 and three bags 2 as in an airbag 10A shown in FIG. 6(a), or may include more bags 1 and 2. Third bags 3 may be provided on the person side of second bags 2, as in an airbag 10B shown in FIG. 6(b). The number of the third bags 3 is three, and a center one of the third bags 3 is disposed between and on the person side of the second bags 2 and 2. Although not shown, fourth bags may be disposed on the person side of the third bags 3.

While the lengths of the bags 1, 2, and 3 are substantially equal in the airbags 10, 10A, and 10B, they may be different.

An airbag 10C shown in FIG. 7 is a curtain airbag that inflates along a side face of a cabin of an automobile 50. In the airbag 10C, second bags 2A and 2B are disposed on the person side (inner side) of first bags 1A disposed on the vehicle-body side. The bag 2A is disposed on the upper sides of the bags 2B, and extends from an A-pillar to the adjacency of a C-pillar. The number of the bags 2B is two, and the bags 2B are disposed beside a front seat and a rear seat, respectively.

Although not shown, the airbag of the present invention is also applicable to, for example, a passenger airbag, a rear-seat airbag, and a leg-protection knee airbag.

What is claimed is:

1. An airbag for a vehicle, the airbag comprising:
a plurality of bags for being deployed in emergency conditions;
a first one of the bags deployed to be inflated closer to vehicle structure than a second one of the deployed and inflated bags; and
internal spaces of the first and second bags that receive inflation gas in emergency conditions with the first bag being inflated outside the internal space of the second bag and the second bag being inflated outside the internal space of the first bag.

2. The airbag according to claim 1, wherein the bags have elongate constructions so that the first one of the bags is inflated to extend along the vehicle structure and the second one of the bags is inflated to extend along the first inflated bag.

3. The airbag of claim 1 wherein the first and second bags have adjacent arcuate portions upon inflation thereof to provide an external space therebetween.

4. The airbag of claim 1 wherein the first and second bags have a cylindrical configuration upon inflation thereof.

5. The airbag of claim 1 wherein the second bag comprises a plurality of second bags arranged so that upon inflation the second bags extend in a longitudinal direction with one over the other.

6. The airbag of claim 5 wherein the first bag is arranged upon inflation to generally extend between two of the second bags that are adjacent each other.

7. The airbag of claim 1 wherein the internal spaces of the first and second bag are of substantially the same size.

8. The airbag of claim 1 wherein the first and second bag include an opening for passage of inflation gas between the internal spaces thereof.

9. The airbag of claim 1 wherein the plurality of bags include a third bag with the second bag deployed to be inflated closer to the vehicle structure than the deployed and inflated third bag.

10. An airbag device for a vehicle, the airbag device comprising:
an airbag for being inflated in a direction along vehicle structure that is transverse to a direction of collision with the vehicle;
a first bag of the airbag that is deployed during the vehicle collision to be inflated adjacent the vehicle structure;
a second bag of the airbag that is deployed during the vehicle collision to be inflated further from the vehicle structure than the deployed and inflated first bag;
an inflator for the airbag; and
internal spaces of the first and second bags for receiving inflation gas from the inflator with the internal space of the first bag being approximately the same size as the internal space of the second bag.

11. The airbag device of claim 10 wherein the first and second bags have an elongate configuration with a lengthwise extent upon inflation and are arranged so that the lengthwise extent of the inflated bags extend in generally the same direction transverse to the collision direction with the vehicle.

12. The airbag device of claim 10 wherein the first and second bags each have a cylindrical configuration upon inflation.

13. The airbag device of claim 10 wherein the second bag comprises a plurality of second bags that are inflated to be stacked one on top of the other in a direction transverse to both the inflation and collision directions.

14. The airbag device of claim 13 wherein the first bag generally extends intermediate a pair of adjacent ones of the second bags upon inflation of the bags.

15. The airbag device of claim 13 wherein the first and second bags have a cylindrical configuration including a central, longitudinal axis extending therethrough with the first bag extending intermediate a pair of the second bags so that the axes thereof form a triangular arrangement of the bags.

16. The airbag device of claim 10 wherein the airbag includes a third bag that is deployed during the vehicle collision to be inflated further from the vehicle structure than the deployed and inflated first and second bags.

17. The airbag device of claim 16 wherein the airbag has a greater number of third bags than second bags, and a greater number of second bags than first bags.

18. The airbag device of claim 10 wherein the airbag has a greater number of second bags than first bags.

19. The airbag device of claim 10 wherein the first bag is inflated outside the internal space of the second bag and the second bag is inflated outside the internal space of the first bag.

20. The airbag device of claim 10 in combination with the vehicle including a passenger compartment, and the airbag is either mounted exterior of the passenger compartment for pedestrian protection or in the passenger compartment for passenger protection.
